(19) United States
(12) Patent Application Publication
(10) Pub. No.: US 2019/0203850 A1
(43) Pub. Date: Jul. 4, 2019

(54) STRUCTURAL UNIT

(71) Applicant: GRUNDFOS HOLDING A/S, Bjerringbro (DK)

(72) Inventors: Ole HANSEN, Bjerringbro (DK); Søren Søgaard JENSEN, Skive (DK)

(73) Assignee: GRUNDFOS HOLDING A/S, Bjerringbro (DK)

(21) Appl. No.: 16/314,161

(22) PCT Filed: Jun. 13, 2017
(86) PCT No.: PCT/EP2017/064384

§ 371 Date: Dec. 28, 2018

(30) Foreign Application Priority Data
Jun. 29, 2016 (EP) 16176865.0

(51) Int. Cl. F16K 31/60; F16K 5/04; F24H 9/20

(52) U.S. Cl. CPC F16K 31/602; F24H 9/2007; F16K 5/0442

(57) ABSTRACT

A construction unit (1, 2) forms part of a gas heater and includes a valve (9) which is actuatable by way of a stem (10). The stem (10) includes positive-fit device. The stem (10) is controllable from the outside via a tool which can be brought into engagement with the positive fit device. A detent engagement device (18, 27) holds the tool (21) in engagement with the stem (10), so that the valve is controllable without the aid of outside tools.

### CROSS REFERENCE TO RELATED APPLICATIONS

This application is a United States National Phase Application of International Application PCT/EP2017/064384, filed Jun. 13, 2017, and claims the benefit of priority under 35 U.S.C. § 119 of European Application 16176865.0, filed Jun. 29, 2016, the entire contents of which are incorporated herein by reference.

### TECHNICAL FIELD

The invention relates to a construction unit for a compact heating facility, with at least one valve which is controllable by hand by way of a shaft and whose shaft comprises positive-fit means at the end side, which is to say at the end, wherein the shaft can be controlled from the outside by way of a tool which is engaged with the positive fit means.

### BACKGROUND

Such construction units are nowadays counted as belonging to the state of the art in various variations. They serve for the supply of the room heating with warm water and/or additionally for the production of warm service water. They are typically part of a gas heater, with which water is heated in a primary circuit by way of a gas combustor. However, they can also be part of a heating system which runs on oil, part of a residential module or likewise. A number of valves, sensors and heat exchangers are typically arranged in such a construction unit, apart from a circulation pump. Such a construction unit regularly comprises a hand-actuatable valve, for example a shut-off valve, with which the heat transfer medium of the primary circuit can be replaced or also supplemented. One or more shut-off cocks, with which an exit conduit can be set in a pressure-free manner or a bleed conduit can be opened, are often provided. One or more of these shafts are led out downwards and at the end side comprise positive-fit means, for example a square or hexagon profile which can be connected to a pliers or another jaw tool, for the purpose of actuation, particularly in the case of construction units for compact heating facilities as are typically applied in a manner hanging on a wall and which in the installed condition are practically only accessible from below.

Inasmuch as it hereby concerns maintenance and service work carried out by the heating technician, this work is not too much of a problem, since he is usually in possession of the necessary tool. A part of this work however can also be carried out by the user himself at irregular intervals, for example inasmuch as it concerns the topping up of the primary circuit with water, the bleeding of the heating circuit and likewise. It is counted as belonging to the state of the art, to supply the tool necessary for this, for example a spanner (wrench) of a simple quality, together with the compact heating facility, so that the user himself can carry out these simple activities.

However, in practice it has been found that the handling of a spanner at the lower side of the heating facility is often quite difficult for the novice or layman, and on the other hand that the spanner is misplaced or lost and the operation then no longer possible.

### SUMMARY OF THE INVENTION

Against this background, it is an object of the invention, to design a construction unit for a compact heating facility of the initially mentioned type, such that an operation can also be carried out by the layman without a special tool.

According to the invention, a detent means or detent engagement device (locking means) holds the tool engaged with the shaft. Firstly, a significantly simpler operation results due to the fact that the tool is held on the shaft by the detent engagement device, which is to say in a locking manner, since the user no longer needs to ensure the retention of the tool on the shaft, but only the hand actuation for the required rotation movement. This significantly simplifies the application. The locking with the shaft moreover serves for the tool always remaining on the shaft, which is to say first of all being secured from being displaced or lost, without any deliberation.

Thereby, it is basically of no significance for the solution according to the invention, as to whether the detent engagement device is arranged at the shaft side or at the tool side or at both sides. However, it has been found to be particularly advantageous if the detent engagement device features are arranged at the tool side.

It is particularly advantageous if the tool itself forms part of the construction unit, which is to say belongs to the construction unit and is connected to this in a suitable manner, where possible in a captive manner. The construction unit according to the invention particularly advantageously forms part of a compact heating facility or residential module, wherein the shaft end and/or the tool projects out to one side in the installed condition. If the compact heating facility or the residential module is assembled hanging on the wall, which is typical, then it is particularly useful to permit the shaft end and/or the tool to project out downwards in the installed condition.

It is particularly advantageous if the shaft end is provided with an outer hexagon profile (external hexagon), and the tool has an inner hexagon profile (hexagonal socket). It is to be understood that suitable other tool profiles, for example Torx, Phillips or similar profiles can likewise be applied here. The combination of the hexagon profiles however is particularly advantageous, since these are also simple to join by the layman, and with a suitable design can also be actuated with an angular offset to one another. The integral formation of an outer hexagon profile on the shaft end of a shaft of metal is also particularly favorable with regard to manufacturing technology.

Thereby, the outer hexagon profile at the shaft end is advantageously configured in a head-like manner, wherein the tool comprises a detent means engaging behind the head. Such a head-like design of the outer hexagon profile, with regard to tools, is counted as belong to the state of the art and not only has the advantage that detent means which engages from behind can be attached, but moreover permits an actuation, even if the longitudinal axes of the shaft and tool are not aligned to one another, but intersect.

The detent means (the detent engagement device) can advantageously be formed by one or more detent or locking tongues which are preferably provided on the tool, in particular on the tool head.

Thereby, the tool according to a further development of the invention is provided with a tubular tool head, whose cross-sectional contour corresponds to the cross-sectional contour of the shaft end and which comprises a detent means. Such a tool head has the advantage that it can be applied in a particularly simple manner. After sticking onto the shaft end, this tool head remains on the shaft end by way of the detent means.

According to an advantageous further development of the invention, the shaft close to its free end is provided with a further positive-fit profile, and specifically preferably on its outer periphery. This positive-fit profile on the outer periphery is advantageously configured as a square profile and seen in the direction to the free shaft end is arranged in front of the positive-fit profile for the tool belonging to the construction unit, thus for example in front of the hexagon profile head on the shaft end. A hexagon profile can alternatively also be provided here. Such an arrangement has the advantage that with this, the shaft also has a profile, as is counted as belonging to the state of the art and which can be actuated with a common jaw tool (spanner tool). This profile is typically envisaged for use by the service installation technician. This profile advantageously has a larger cross section than the subsequent profile at the shaft end, said subsequent profile being engaged with the tool of the construction unit. By way of this, one succeeds in a larger moment than is possible with the tool belonging to the construction unit, being able to be applied, by way of attaching a jaw tool to this profile. This is a safeguard aspect, by which means it is ensured that the end-user cannot overtighten the shaft, but only the expert, who whoever knows which force must and is permitted to be applied with a suitable tool, without damage to the shaft or the valve occurring. This aspect is particularly important if the shaft has seized due to lack of actuation.

The tool belonging to the construction unit is advantageously configured such that it comprises a tool head which is envisaged for the engaging over the profiled shaft end in a locking manner, which is to say by detent, as well as a tool grip which is envisaged for being gripped around by the hand. These two tool parts are connected by a tool shank which creates the necessary distance, so that adequate free space is given for the manual actuation, without the danger of injury on a covering part or likewise, which for example has sharp edges. The tool head and the tool grip are arranged at ends of the shank which are away from one another and thus largely rule out any faulty operation.

Such a tool can advantageously be configured as a single-piece plastic component which is preferably fiber-reinforced, so that the necessary forces can also be reliably transmitted.

If the tool is configured as a plastic injection molded part, which is advantageous, then this on the one hand can be inexpensively manufactured, and on the other hand the spring tongue or spring tongues as well as the tool head can be configured such that they can be manufactured with a simple tool without lost cores, differently than would conversely be the case at the shaft end.

The shaft in contrast usefully consists of metal, but can however also be formed from a suitable different material. The shaft advantageously forms the valve stem of a shut-off valve or part of the shut-off cock, thus the part, on which the plug which is to say the closure element is arranged at the valve-side end.

The construction unit is advantageously itself configured as a plastic injection molded part or is formed from plastic injection molded parts, and is envisaged for receiving components and/or for the connection of at least one conduit. Components in the context of the present invention can be sensors, valves, pumps, switch devices and likewise.

Even if the tool according to the invention is connected to the shaft end by detent, and, inasmuch as this is concerned, there is no danger of the tool getting lost, however, its deliberate detachment however is not ruled out. Embodiments with which two or more shaft ends are provided and on which ends the tool can be placed are also conceivable, wherein then an individual tool does necessarily need to be provided for each shaft end. In these cases, it is particularly useful if a flexible holding element is provided between the construction unit and the tool, so as to captively fix the tool on the construction unit. Such a holding element for example can be a securing cord, a wire, a ball chain or likewise. Such a cord on the tool side on the one hand can be fastened for example to an opening in the tool grip and on the other hand to an eyelet or suitable opening on the construction unit itself.

The invention is hereinafter explained in more detail by way of an embodiment example represented in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a front view showing a construction unit for a compact heating facility in the installed condition;

FIG. 2 is a front view showing the construction unit according to FIG. 1, without a tool;

FIG. 3 is a front view showing the construction unit according to FIG. 1, by way of example with four shaft/tool arrangements;

FIG. 4 is a simplified perspective view of the tool;

FIG. 5 is a simplified perspective view of the tool from the tool head side;

FIG. 6 is a simplified perspective view of the stem drive of a shut-off valve;

FIG. 7 is a lateral view of a shut-off cock with a tool;

FIG. 8 is a front view of the shut-off cock according to FIG. 7;

FIG. 9 is a sectional view along section line A-A in FIG. 8; and

FIG. 10 is a side view of the shut-off cock from the side which is at the left in FIG. 8.

### DESCRIPTION OF PREFERRED EMBODIMENTS

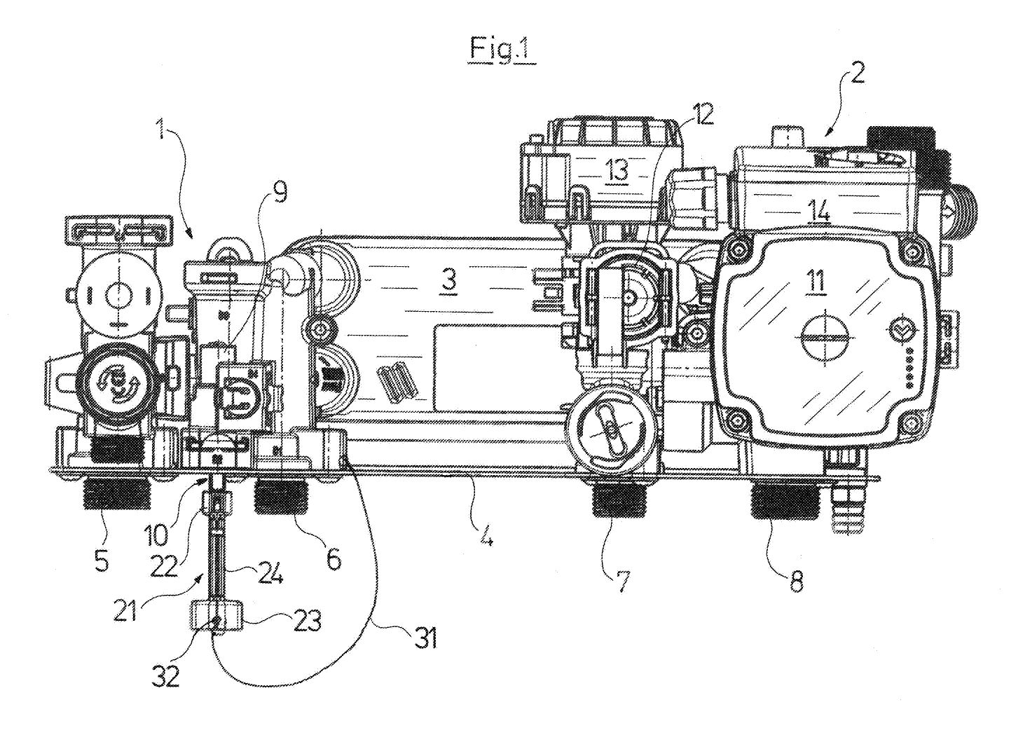

Referring to the drawings, with the construction unit which is represented in FIG. 1-3, it is the case of a construction unit of a compact heating facility, specifically of a gas heater, which with regard to basic construction aspects is described for example in EP 2 093 516 B 1, which is referred to inasmuch as this is concerned (the entire contents of EP 2 093 516 B1 are incorporated herein by reference). The construction unit is comprised of two part-construction-units 1 and 2 which are hydraulically and mechanically connected to one another by a plate heat exchanger 3. The construction unit is received by a plate 4 which runs approximately horizontally in the installed condition and which forms part of the part of the chassis of the compact heating facility, said facility being fastened to a wall at the rear side and with which facility the four conduit connections 5, 6, 7, 8 of the part-construction-units 1 and 2 are led out at the lower side. These conduit connections 5-8 are provided for the feed and return of the room heating, for the feed of cold service water as well as the exit of service water heated in the heat exchanger 3.

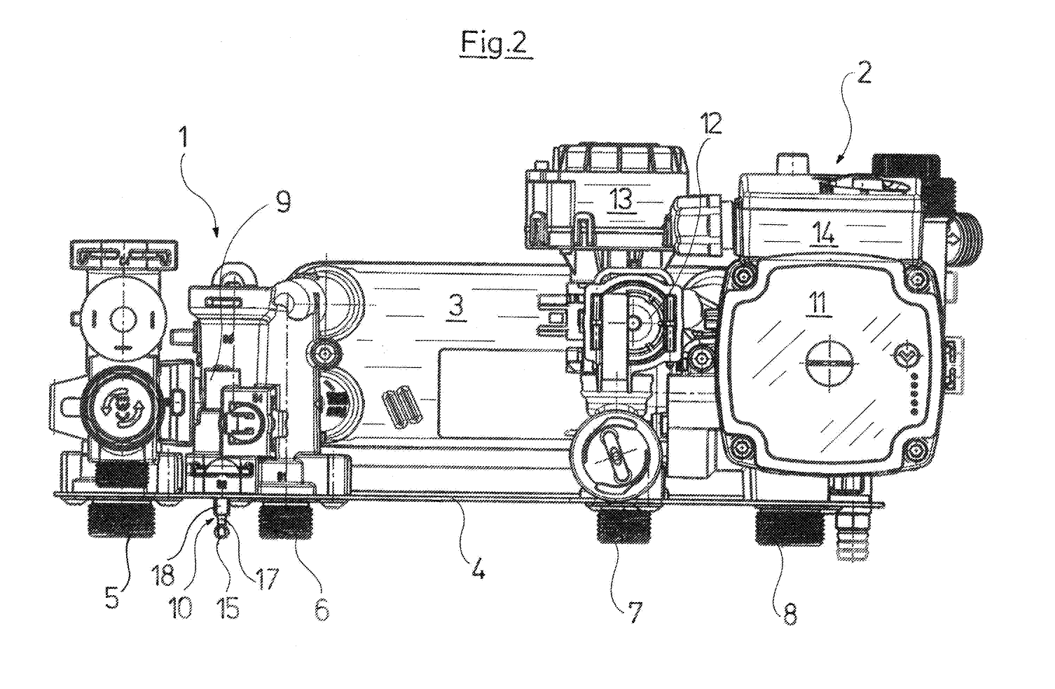

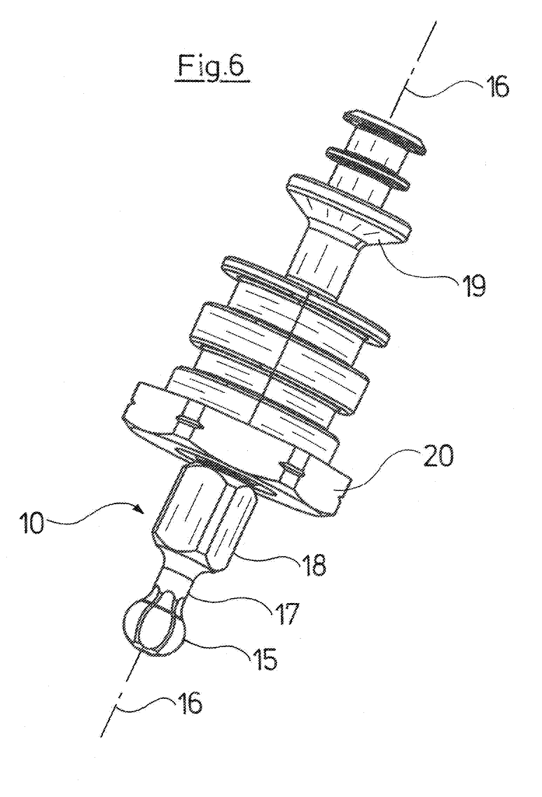

The left part-conduction-unit 1 which connects at the rear side to the plate heat exchanger 3 comprises a filling valve 9, with which a conduit of the construction unit which leads service water is connectable to the heating circuit connected to the room heating. This filling valve 9 comprises a shaft 10 for the manual opening and closure, wherein this shaft forms a valve stem 10 and part of the stem drive which is represented by way of FIG. 6. The free end of this shaft 10 projects outwards at the lower side of the construction unit 1, in a manner passing through the plate 4, as can be seen best of all in FIG. 2.

The part-construction unit 2 which is at the right in the installed condition comprises a circulation pump 11, with an electromotorically controlled switch-over valve 12, whose electric motor 13 is visible in the figures. The circulation pump 11 laterally at the top on the motor casing comprises a terminal box 14 which receives the control electronics for the pump and via which the electrical connections are led outwards. The arrangement of the part-construction-units 1 and 2 as well as their components, here to be understood as only being exemplary, but what is essential to the present invention is the shaft 10 which is led downwards, penetrating the plate 4, out of the construction unit.

This shaft 10 at its end comprises a shaft head 15 which is configured in a ball-like manner and is provided with an outer hexagon profile, as can be recognized by way of FIG. 6. The shaft head 15, with respect to its middle longitudinal axis 16 has an outer hexagon profile which follows the head contour and is configured in such an undercut manner that a shaft section 17 results, whose diameter is smaller than the smallest diameter of the shaft head 15. A section 18 which is provided with an outer square profile envisaged for the engagement of a jaw tool, for example of spanner, a monkey wrench or pliers, connects to this neck-like shaft section 17. The smallest diameter in the region of this section 18 is larger than the largest diameter in the region of the shaft head 15, which is to say the surfaces of the outer square profile which lie opposite and away from one another, in the region of the section 18 are distanced further to one another than the surfaces of the outer hexagon profile which lie opposite and away from one another, in the region of the shaft head 15.

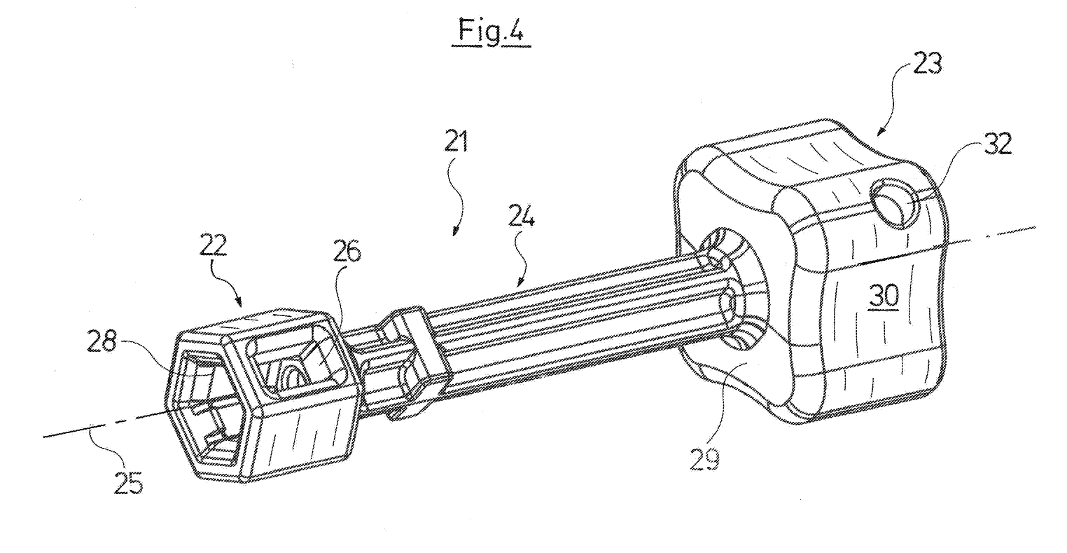

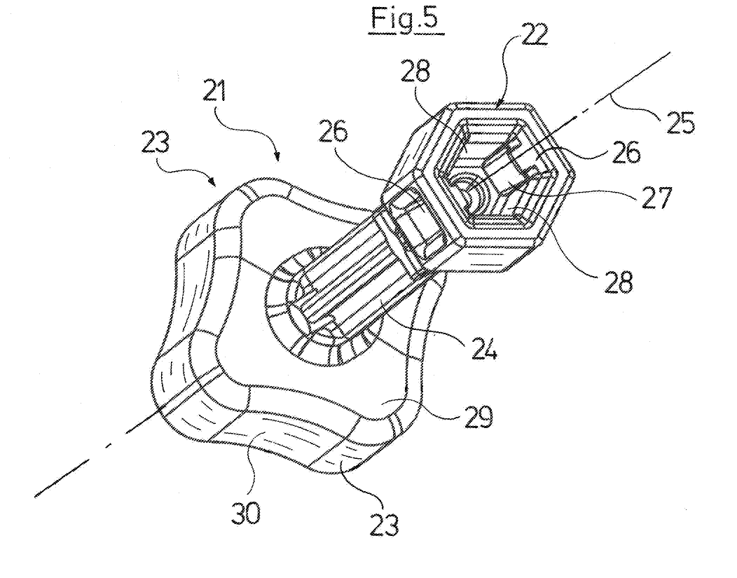

With regard to its further course, the shaft then merges into the shaft section which is not visible in FIG. 6 and which forms part of the actual stem drive, with which stem drive a sealing body 19 is axially movable with respect to the sealing seat in the construction unit 1 and to a stationary fastening part 20, when the shaft 10 is rotated in the one or other direction. The stationary fastening part 20 is arranged and fixed on a suitable recess of the construction unit 1 in a rotationally fixed manner.

Whereas the shaft section 18 with its external square is envisaged for engagement with a spanner or another suitable tool, a tool 21 which is represented in FIGS. 4 and 5 is seated on the shaft head 15. This tool 21 is configured as a fiber-reinforced plastic injection molded part and comprises a tool head 22, a tool grip 23 and a shank 24 which connects these.

The tool head 22 comprises a hexagonal outer and inner contour in the direction of the longitudinal axis 25 of the tool 21. The axial length of the tool head 22 corresponds roughly to the axial length of the shaft head 15, for which it is configured to receive. The tool head 22 at two opposite sides of this comprises recesses 26, on whose inner side spring tongues 27 are arranged, said spring tongues projecting inwards beyond the hexagon contour and being able to resiliently back away into the respective recess 26. When sticking the tool 21, in particular the tool head 22 onto the shaft head 15, these spring tongues 26 are moved radially outwards, until they spring back radially inwards behind the head, thus in the region of the neck-like shaft section 17, and thus fix the tool head 22 and, with this, the complete tool 21 on the shaft 10 in a locking manner or by detent. Thereby, four inner surfaces 28 bear on corresponding sides of the outer hexagon profile of the shaft head 15, so that a torque can be transmitted onto the shaft 10 via the shaft head. The spring tongues 27 thereby hold the tool 21 on the shaft head 15 of the shaft 10 in a fixed manner.

The shaft head 22 is connected as one piece to the shaft shank 24 which is roughly cross-shaped in cross section, connects to this head and at whose other end the tool grip 23 is arranged, said tool grip here having a roughly square, rounded cross-sectional shape which is connected to the shank 24 via a base 29 which is arranged transversely to the longitudinal axis 25. The tool grip 23 is configured in a hollow manner in the same manner as the head 22, so that departing from the end of the shank 24, it firstly extends into the base 29 extending transversely to the longitudinal axis 25, and from there, bent by 90 extends into the annular grip region 30 which with regard to shape and dimensioning is configured such that it lies in the surface of the hand as a grip.

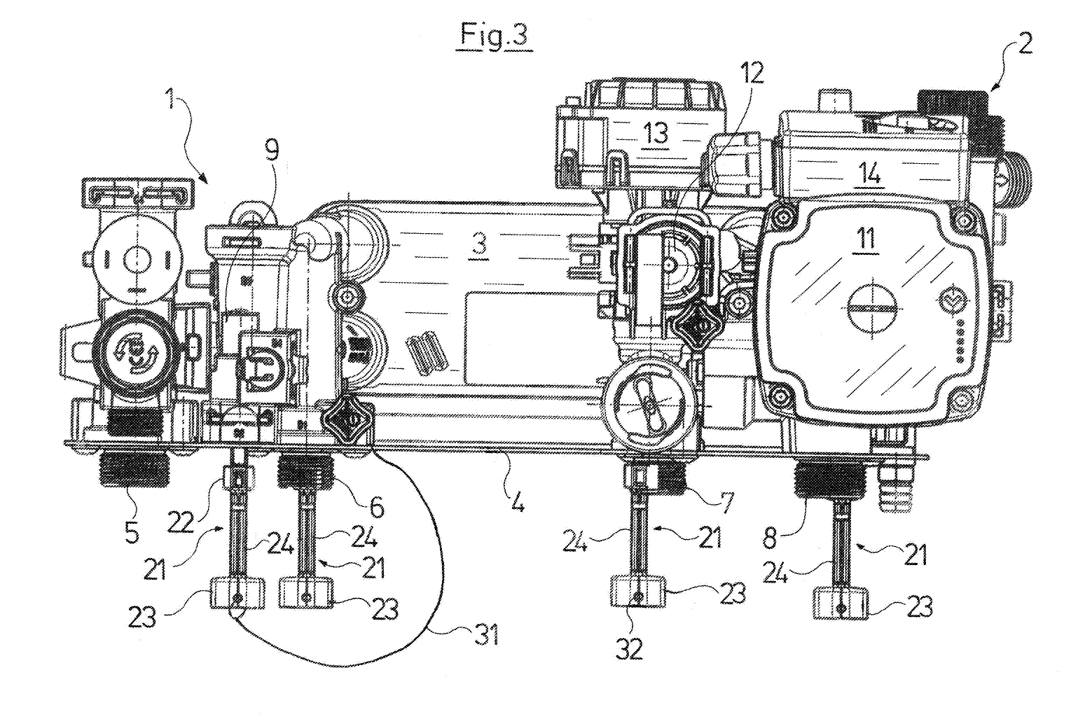

The tool grip 23 in the region of the wall forming the grip region 30 comprises a recess 32, to which a securing band 31 represented in FIGS. 1 and 3 is attached, the end of which securing band being fastened to the construction unit 1. This securing band 31 ensures that even if the tool 21—for whatever reason—has been removed from the shaft head 15, it cannot get lost, but remains hanging on the securing band 31 at a distance below the construction unit 1.

This comparatively lightweight plastic tool 15 is usually seated on the shaft head 15, in a manner locked by detent by way of the spring tongues 27, so that the operator merely needs to grap the grip 23 part and rotate this in the one or other rotation direction, for rotating the valve stem. The tool 21 is only removed from the shaft head 15 when it gets in the way of other work. It then hangs on the securing band 31, below the part-construction-unit 1, thus remains well visible, accessible by hand and away from the lower side of the plate 4 by a sufficient distance, so that it can be placed back on the shaft head 15 at any time with a grip of the hand.

By way of example, FIG. 3 shows how several such tools 21 which control certain valve functions or also other functions, can be located on shafts, on a construction unit. Thereby, a tool 21 does not necessary have to be seated on each of the shafts 10 projecting downwards out of the construction unit, but it is also conceivable to provide a common tool 21 which depending on requirement is stuck onto the one or other shaft head. Since the shaft head 15 is configured in a ball-like manner, the tool 21 can also be arranged in the positions where the shaft exits downwards out of the construction unit, after one of the connection 6, 7 or 8 in the assembly direction and passing through the plate 4, said positions being at the right in FIG. 3. The complete tool 21 can be pivoted laterally, since the shaft head 15 has a ball-like shape and is undercut to a sufficient extent in the region of the neck-like section 17, in order to then reach the tool grip 23 which typically lies behind a pipe conduit.

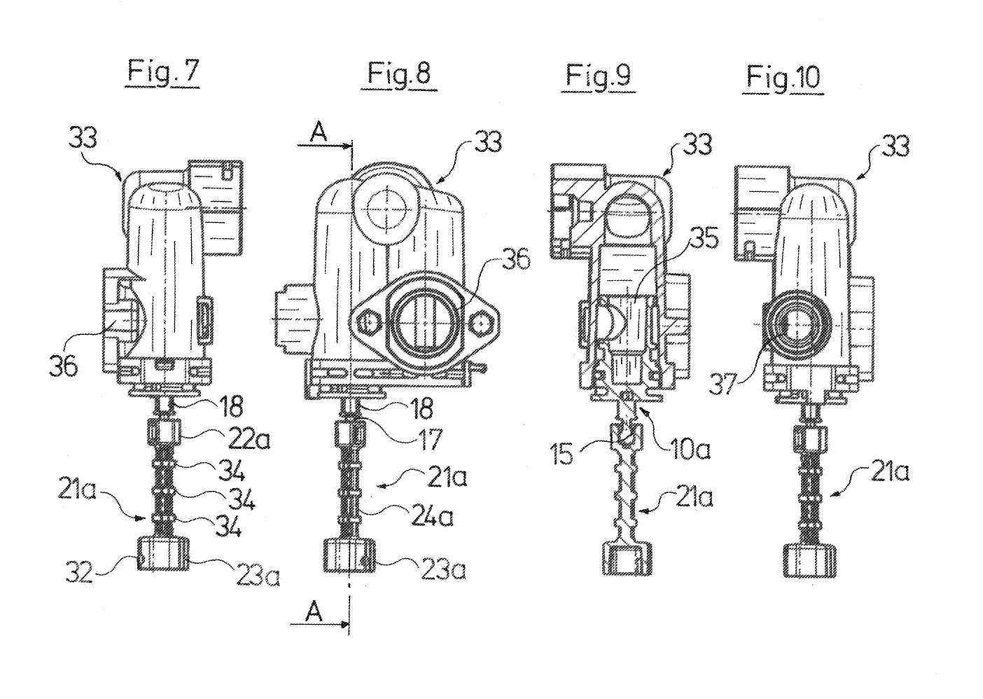

A valve of the construction unit is represented by way of example by way of FIG. 7-10. This valve 33 which can be manually controlled by way of a shaft 10a, in the same manner as the previously described filling valve 9 on the shaft 10a comprises a shaft head 15, a shaft neck 17 connecting thereto, as well as a section 18 with a square outer profile. The tool 21a is constructed analogously to the tool 21, but has a tool grip 23a which is circularly round in cross section, as well as a shank 24a with three reinforcement rings 34. The valve 33 however is not configured as a stem valve, but as a shut-off cock comprising a plug 35 which is rotatably arranged within the valve housing and with which the connections 36 and 37 of the valve can be hydraulically connected to one another and separated from one another, depending on the rotational position of the shaft 10a.

While specific embodiments of the invention have been shown and described in detail to illustrate the application of the principles of the invention, it will be understood that the invention may be embodied otherwise without departing from such principles.

1. A construction unit for a compact heating facility, the construction unit comprising:
at least one valve;
a shaft, the at least one valve being hand-controllable by way of the shaft comprising a positive-fit profile at a shaft end side, wherein the shaft can be controlled from the outside by way of a tool which is engaged with the positive-fit profile;
a detent engagement device which holds the tool in engagement with the shaft.

2. A construction unit according to claim 1, wherein the tool forms part of the construction unit.

3. A construction unit according to claim 1, wherein the construction unit forms part of a compact heating facility or a residential module, and that the shaft end and/or the tool projects out to one side, in an installed condition.

4. A construction unit according to claim 2, wherein the shaft end is provided with an outer hexagon profile and the tool comprises an inner hexagon profile.

5. A construction unit according to claim 4, wherein the outer hexagon profile is configured as a head and the tool comprises the detent engagement device which engages behind the head.

6. A construction unit according to claim 5, wherein the detent engagement device is comprised by at least one spring tongue which forms part a tool head of the tool.

7. A construction unit according to claim 5, wherein the tool comprises a tubular tool head having a tool head cross-sectional inner contour that corresponds to a cross-sectional outer contour of the shaft end and which comprises the detent engagement device.

8. A construction unit according to claim 1, wherein adjacent to a shaft free end of the shaft a further positive-fit profile is provided for engagement with an external tool.

9. A construction unit according to claim 8, wherein the further positive-fit profile comprises a square profile arranged in front of the positive-fit profile for the tool belonging to the construction unit.

10. A construction unit according to claim 2, wherein the tool comprises a tool head, a tool shank and a tool grip (23), wherein the tool head and the tool grip (23) are arranged at ends of the tool shank.

11. A construction unit according to claim 2, wherein the tool is configured as a single-piece, fiber-reinforced plastic component.

12. A construction unit according to claim 2, wherein the tool is configured as a plastic injection molded part.

13. A construction unit according to claim 1, wherein the shaft consists of metal and forms a valve stem of a shut-off valve or a part of a shut-off cock.

14. A construction unit according to claim 1, wherein the construction unit is configured as a plastic injection molded part for receiving components and/or for connection of at least one conduit.

15. A construction unit according to claim 1, wherein the construction unit is captively connected to the tool via a flexible holding element.

16. A tool for a manual actuation of a valve of a construction unit of a compact heating facility, wherein the construction unit further comprises a shaft and the valve is hand-controllable by way of the shaft and the shaft comprises a positive-fit profile at a shaft end side, wherein the shaft can be controlled from the outside by way of the tool which is engaged with the positive-fit profile, wherein the tool comprses at least a portion of a detent engagement device which holds the tool in engagement with the shaft.

17. A tool according to claim 16, wherein the tool forms part of the construction unit.

18. A tool according to claim 16, wherein the detent engagement device is comprised by at least one spring tongue which forms part of a tool head of the tool.

19. A tool according to claim 16, wherein the tool comprises a tubular tool head having a tool head cross-sectional inner contour that corresponds to a cross-sectional outer contour of the shaft end and which comprises the detent engagement device.

20. A tool according to claim 16, further comprising a tool head, a tool shank and a tool grip, wherein the tool head and the tool grip are arranged at ends of the tool shank.
